(19) United States
(12) Patent Application Publication
(10) Pub. No.: US 2020/0277160 A1
(43) Pub. Date: Sep. 3, 2020

(54) LIFT SYSTEM HAVING A SIGNAL GENERATION UNIT ARRANGED ON A LIFT CAR OF THE LIFT SYSTEM

(71) Applicant: thyssenkrupp Elevator Innovation and Operations AG, Essen (DE)

(72) Inventors: Richard THUM, Kornwestheim (DE); Marius MATZ, Filderstadt (DE); Eduard STEINHAUER, Nürtingen (DE)

(73) Assignee: thyssenkrupp Elevator Innovation and Operations AG, Essen (DE)

(21) Appl. No.: 16/763,111

(22) PCT Filed: Nov. 9, 2018
(86) PCT No.: PCT/EP2018/080744

§ 371 Date: May 11, 2020

(30) Foreign Application Priority Data
Nov. 21, 2017 (DE) 10 2017 220 766.3

(51) Int. Cl. B66B 5/06; B66B 11/04; G01B 7/00; G01P 15/105

(52) U.S. Cl. CPC B66B 5/06; G01P 15/105; G01B 7/003; B66B 11/0407

(57) ABSTRACT

An elevator system including a cab displaceably received within an elevator shaft and a linear drive embodied to drive the cab. A sensor is disposed in the elevator shaft and a signal generation unit is disposed on the cab. The signal generation unit is embodied to generate a measurement signal in the sensor, the measurement signal depending on a displacement speed of the cab in the elevator shaft. Further, the elevator system has a safety control unit configured to ascertain an acceleration of the cab on the basis of the measurement signal and to bring the linear drive into a safety operating state should the ascertained acceleration exceed a limit value.

The invention relates to an elevator system having a signal generation unit disposed on a cab of the elevator system and a sensor, disposed on the elevator shaft, for detecting a signal of the signal generation unit. Consequently, a speed or acceleration of the cab can be ascertained reliably and quickly.

The linear drive has now emerged as an alternative to the cable drive in elevator construction. Such a linear drive comprises stator units fixedly installed in the elevator shaft and at least one rotor unit fixedly installed on the cab. The invention is applicable to an elevator system having a cab and such a linear drive for driving the cab. Elevator systems with a linear motor drive, where the primary part of the linear motor is provided by appropriately embodied guide rails of the elevator system and the secondary part of the linear motor is provided by a carriage of a cab, which comprises the rotor of the linear motor, are disclosed in DE 10 2010 042 144 A1 or DE 10 2014 017 357 A1, for example.

When traveling upward, the cab can be braked by no more than the gravitational acceleration as a matter of principle. The fastest possible borderline safe deceleration can be achieved by setting the drive into neutral. If further downwardly directed braking forces act on the cab in addition to gravitational acceleration, the cab is braked with a deceleration that, in terms of magnitude, is greater than the gravitational acceleration. This increased deceleration can already be generated by the rolling resistance of guide rollers.

For people in the cab, this means a loss of contact with the floor and hence a considerable risk of injury. In order to design the braking to be comfortable for the passenger, the drive power is continuously reduced for braking purposes. This results in deceleration that is significantly smaller than gravitational acceleration.

Firstly, a malfunction of the linear drive can lead to interruption of the driving force in the upward direction, and so the cab is decelerated on account of the gravitational acceleration. Secondly, a short circuit can suddenly generate a downward acting driving force on the cab. Consequently, the cab is decelerated at a greater rate than the gravitational acceleration and the passenger is inevitably thrown head first in the direction of the ceiling and, in the worst case, against the ceiling. Further, accelerations directed in the direction of the cab floor and which compress the passenger or press them against the floor are not without danger, even if less severe injuries are to be expected in this case and a passenger can better compensate this action of force.

Such a dangerous deceleration of the cab can be ascertained by way of an acceleration sensor attached to the cab. However, the ascertained deceleration value must be transmitted very quickly to a safety device, which can initiate suitable safety measures. Use is increasingly being made of wireless data transmission paths for transmitting signals between a cab and units installed in the shaft in order to be able to dispense with the traveling cable. It is no longer possible to use such traveling cables in the case of elevator systems with more than two cars (or cabs) per shaft. However, the existing wireless data transmission paths, e.g., WLAN, delay the data transmission by important milliseconds and are therefore too slow and hence too unreliable.

The object of the present invention therefore consists of developing an improved concept for measuring the acceleration of a cab in an elevator system with a linear drive.

The object is achieved by the subject matter of the independent patent claims. Further advantageous embodiments are the subject matter of the dependent patent claims.

Embodiments disclose an elevator system comprising a cab displaceably received within an elevator shaft and a linear drive (also referred to as linear motor drive, linear motor, abbreviated: drive) embodied to drive the cab. A sensor is disposed in the elevator shaft and a signal generation unit is disposed on the cab. The signal generation unit is embodied to generate a measurement signal in the sensor, the measurement signal depending on a (displacement) speed of the cab in the elevator shaft. Further, the elevator system has a safety control unit embodied to ascertain an acceleration of the cab on the basis of the measurement signal and to bring the linear drive into a safety operating state should the ascertained acceleration exceed a limit value.

By using sensors fixedly installed in the elevator shaft, it is possible to dispense with both wireless data transmission and data transmission of the deceleration values by way of traveling cable. Consequently, data transmission can also be implemented in wired fashion, even without a traveling cable, and hence said data can be transmitted very quickly to the safety control unit (safety device), which initiates suitable safety measures. It is a concept of the present invention to (mechanically) modulate an (electromagnetic or magnetic) signal generated on the cab by way of the movement of the cab relative to the sensor disposed in the elevator shaft. The signal modulated in this way is detected in the sensor and converted into an electrical signal which can be (electrically) demodulated or processed. This common inventive concept is explained below in three different aspects, respectively with exemplary embodiments.

Thus, in one exemplary embodiment of a first aspect, the signal generation unit has an alternating arrangement of a first section and a second section. The sensor comprises a transmitter and a receiver, wherein the receiver is embodied to receive an electromagnetic signal emitted by the transmitter. The first section is embodied to guide the electromagnetic signal to the receiver and the second section is embodied to prevent the electromagnetic signal from being guided to the receiver. The receiver outputs the measurement signal on the basis of the received portion of the electromagnetic signal, i.e., the portion of the electromagnetic signal that is incident on the first section. The sensor can be a photoelectric barrier which, for example, emits light in the visible spectrum or in the infrared spectrum. Transmitter and receiver (of the photoelectric carrier or of the sensor) can be disposed in such a way that the emitted electromagnetic signal is reflected by the signal generation unit for reception purposes so that the receiver can receive the part of the emitted electromagnetic signal that is incident on the first section of the signal generation unit. Then, the transmitter and the receiver are disposed in the elevator shaft on the same side of the cab. Alternatively, transmitter and receiver (of the photoelectric barrier or of the sensor) can be disposed in such a way that the emitted electromagnetic signal is transmitted by the signal generation unit for reception purposes so that the receiver can receive the part of the emitted electromagnetic signal that is incident on the first section of the signal generation unit. In this case, the perforated tape is preferably disposed vertically on the cab. That is to say, the electromagnetic signal passes through the transmitting part of the perforated tape (e.g., a hole) when it extends substantially parallel to a wall of the cab. Then, the transmitter and the receiver are preferably disposed on different sides of the elevator shaft, for example on opposing sides. Alternatively, the transmitter and receiver can also be disposed on the same side of the elevator shaft, with the transmitter emitting the electromagnetic signal substantially parallel to this side of the elevator shaft. In both cases, the perforated tape is guided between transmitter and receiver.

The signal generation unit can be a perforated tape (also a perforated grid tape), which has a material and a substance deviating from the material in regions where material has been punched out, wherein the material forms one section (typically the first section if the reflection is detected and typically the second section if the transmission is detected) and the substance forms the other section of the signal generation unit. The substance can be air or a material with for example a reflection coefficient or transmission coefficient for the electromagnetic radiation emitted by the transmitter that differs from the material of the perforated grid tape. Thus, the transmitter can receive the electromagnetic signal incident on one of the two regions while the signal is not guided to the receiver upon incidence on the other of the two regions and consequently cannot be received. Consequently, the perforated grid tape generates a pulsed signal (the measurement signal) in the receiver from the electromagnetic signal by suppression in at least one section when the electromagnetic signal strikes the second section. The safety control unit can determine the speed from the pulse frequency of the measurement signal and the (positive or negative) acceleration of the cab from the change in the pulse frequency.

In an exemplary embodiment of a second aspect, the signal generation unit comprises a multiplicity of magnets disposed in such a way that they alternately (in alternating fashion) generate a magnetic field in a first direction and in a second direction in the elevator shaft. The sensor has a magnetic field detector embodied to detect the alternating magnetic field and ascertain the acceleration of the cab on the basis of the alternating magnetic field. The multiplicity of magnets can be aligned so that a north pole and a south pole alternately face the sensor in order to generate the 1st and the 2nd direction of the magnetic field. Consequently, the sensor is exposed to alternating magnetic fields in the case of a relative movement between the cab and the sensor. This permanent change in the magnetic field (or the magnetic flux) generates (induces) an alternating electric current (or an AC voltage) in the magnetic field sensor, e.g., a coil. A frequency of the induced AC voltage or of the alternating current depends on (or is proportional to) the speed of the cab. The acceleration can be ascertained from a change in frequency (first derivative of the frequency). This exemplary embodiment is advantageous since the signal generation unit is insensitive to (usual) dirtying.

In an exemplary embodiment of a third aspect, the signal generation unit has a plurality of coils, wherein a first coil of the plurality of coils is coupled to an alternating current source embodied to feed the first coil with an alternating current flow with a first phase displacement and a constant frequency. Further, a second coil of the plurality of coils is coupled to the alternating current source. The alternating current source is embodied to feed the second coil with an alternating current flow with a second phase displacement and the constant frequency. The first phase displacement differs from the second phase displacement. The difference is, for example, 180°. An alternating current flows through each coil and consequently generates a changing (rotating) alternating magnetic field, i.e., a traveling field. This is advantageous since the sensor can detect a measurement signal, even when the cab is at a standstill. Thus, a sensor failure can be detected directly when the cab is in front of the sensor, for example. Likewise, the signal generation unit is less sensitive in relation to (usual) dirtying.

The alternating magnetic field of each coil is (mechanically) modulated in the case of a relative movement between the cab and the sensor, i.e., when the cab travels past the sensor. If the sensor is exposed to the alternating magnetic field, a corresponding alternating current (measurement signal) that depends on the speed of the cab is induced in the sensor. In the case of a phase difference of 180° between adjacent alternating magnetic fields, the alternating magnetic field (carrier frequency) is modulated with an envelope of a frequency corresponding to the speed of the cab. The speed of the cab can be ascertained from this frequency and/or a change in amplitude of the measurement signal. The envelope is comparable to the measurement signal of the second aspect. Expressed differently, the low-pass-filtered measurement signal of this exemplary embodiment is comparable to the measurement signal of the second aspect. Accordingly, the acceleration is determined as per the exemplary embodiment of the second aspect.

In a further exemplary embodiment of the third aspect, the plurality of coils has, in addition to the previous exemplary embodiment, a third coil and a fourth coil. The difference between the first phase displacement (first coil) and the second phase displacement (second coil) is 90°. The alternating current source is embodied to feed the third coil with the alternating current of the first coil phase-shifted by 180° and feed the fourth coil with the alternating current of the second coil phase-shifted by 180°.

The 180° phase offset can be generated by the winding of two coils with an opposite winding sense if both coils a fed with the same AC voltage. If two such coils are disposed nested in one another with two identical coils which, however, are fed with an AC voltage shifted by 90°, then four alternating magnetic fields, in each case shifted by 90°, arise in the elevator shaft. Expressed differently, the alternating current source is embodied to feed adjacent coils of the plurality of coils with a Hilbert-transformed signal of the neighboring coil. Starting from a sine voltage (sin) on the first coil, the second coil is fed with the 180°-shifted cosine (−cos), the third coil is fed with the 180°-shifted sine (−sin) and the fourth coil is fed with the cosine (cos). The plurality of coils are disposed in ascending order along a direction of travel of the cab in accordance with their numbering (first, second, third, fourth coil). The plurality of coils is extendable by any number of further coils until a maximum height (extent or extension of the cab in the direction of travel) is occupied by coils. Incidentally, this generally applies analogously to the respective signal generation units of the three aspects.

Adjacent coils being fed with the Hilbert-transformed signal of the adjacent coil is advantageous in that the signals are phase-shifted by 90° and consequently perpendicular to one another. Expressed differently, the signals are orthogonal to one another or uncorrelated. Orthogonal signals are well suited as carrier signals for transmitting two used signals over the same channel since the used signals can be extracted or demodulated, theoretically an ideal fashion, from the received measurement signal (at any time).

A further advantage of using 90° phase-shifted (sinusoidal or cosine-shaped) carrier signals arises from the modulation with the moving cab. Here, different components of the carrier signal are detected by the sensor at all times. Consequently, the sensor receives the carrier signal, albeit with a phase angle that is unique for each point in the region of the four successive coils in comparison with a sinusoidal voltage without phase shift. Consequently, the position of the cab relative to the sensor can be determined from the phase angle. The speed of the cab emerges from the derivative of the position and the second derivative of the position supplies the acceleration of the cab. Expressed differently, for the purposes of ascertaining the acceleration of the cab, the safety control unit can determine a phase angle of the measurement signal in order to obtain a position of the cab and differentiate the phase angle twice with respect to time in order to ascertain the acceleration of the cab. The use of the phase angle for transmitting information has a number of advantages. Firstly, there is a very precise determination of position. Depending on the embodiment of the coils or of the sensor and depending on the speed of the cab, a resolution of the position of the cab lies between a few millimeters and a few centimeters. Further, the determination of the phase angle is robust in relation to amplifications and attenuations of the amplitude of the measurement signal since it is not the amplitude but the phase that is evaluated, the latter being independent of the amplitude.

According to one exemplary embodiment of the third aspect, the safety control unit can comprise a demodulator for ascertaining the acceleration of the cab, said demodulator demodulating the measurement signal by means of coherent demodulation. Coherent demodulation represents an easy-to-implement option for decoding the measurement signal with the Hilbert-transformed (i.e., respectively 90° phase-shifted) carrier signals and obtaining the used signals. Both modulation signals are obtained by multiplying the measurement signal by the carrier signal and multiplying the measurement signal by the Hilbert-transformed carrier signal. By-products of this demodulation can be filtered out with a low-pass filter. It is possible, at any time, to read the in-phase component or the x-component of the phase angle from the first used signal and the quadrature component or y-component of the phase angle from the second used signal.

In a further exemplary embodiment, the frequency of the measurement signal is evaluated instead of the phase angle using known methods. Just like the phase angle, the current frequency of the measurement signal depends on the travel speed of the cab. Alternatively, coherent demodulation can also be used here to obtain the two modulation signals. The speed of the cab can then be ascertained on the basis of the frequency of the modulation signals. This can be implemented analogously to the determination of the speed of the cab in the second aspect.

Further, a method is disclosed for operating an elevator system, including the following steps: displacing a cab displaceably received within an elevator shaft; driving the cab using a linear drive; disposing a sensor in the elevator shaft; disposing a signal generation unit on the cab; generating a measurement signal in the sensor, wherein the measurement signal depends on a speed of the cab in the elevator shaft; ascertaining an acceleration of the cab on the basis of the measurement signal; bringing the linear drive into a safety operating state should the ascertained acceleration exceed a limit value.

Furthermore, a method is disclosed for measuring an acceleration of a cab of an elevator system, including the following steps: generating a succession of at least four alternating magnetic fields on the cab, which differ from one another, wherein adjacent alternating magnetic fields are perpendicular to one another in each case, wherein the succession of the at least four alternating magnetic field is strung along a direction of travel of the cab, and wherein the succession of at least four alternating magnetic fields generates a resultant magnetic field; displacing the cab displaceably received within an elevator shaft of the elevator system; measuring a measurement signal at a measurement position in the elevator shaft, the measurement signal being generated by the resultant magnetic field when the cab passes this measurement position; decoding the measurement signal in order to obtain information relating to an acceleration of the cab at the measurement position in the elevator shaft. The information relating to the acceleration of the cab can be, e.g., the position or the speed of the cab, from which the acceleration can be ascertained by differentiation or by determining the change therein. The measurement position in the elevator shaft is the position at which the sensor is disposed.

In the exemplary embodiments of the method, decoding the measurement signal comprises the following steps: determining a sequence of positions of the cab relative to the measurement position in the elevator shaft from the phase angle of the measurement signal; differentiating a position of the cab twice in order to obtain the acceleration of the cab at the measurement position of the cab.

According to further exemplary embodiments of the method, the phase angle of the measurement signal is determined from a first and a second modulation signal, wherein the first modulation signal modulates a first alternating magnetic field of the at least four alternating magnetic fields and wherein the second modulation signal modulates a second alternating magnetic field of the at least four alternating magnetic fields, wherein the first and the second modulation signal emerge from the displacement of the cab relative to the measurement position.

The methods can be implemented in a program code of a computer program for performing the method when the computer program is executed on a computer.

Preferred exemplary embodiments of the present invention are explained below, with reference being made to the attached drawings. In the drawings:

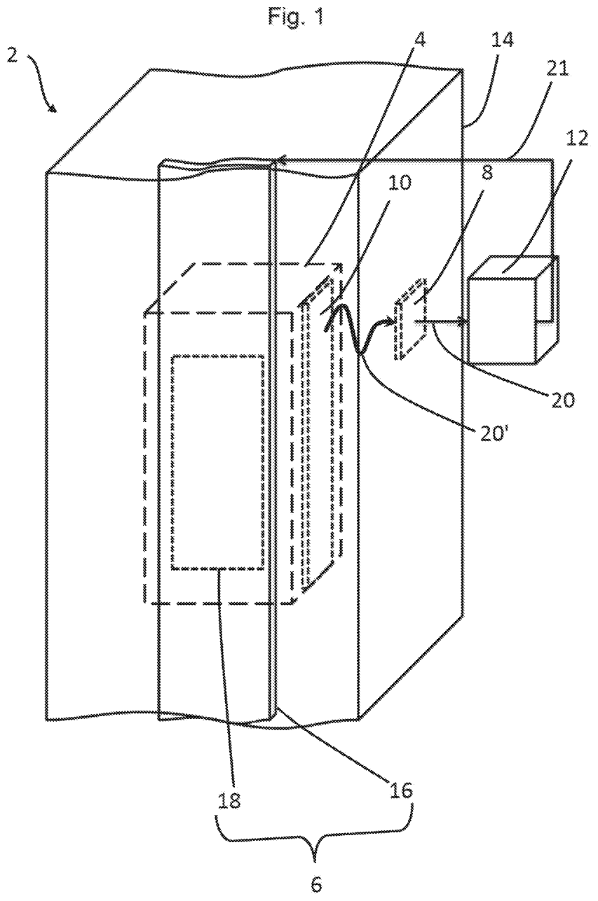

FIG. 1: shows a schematic illustration of an elevator system 2;

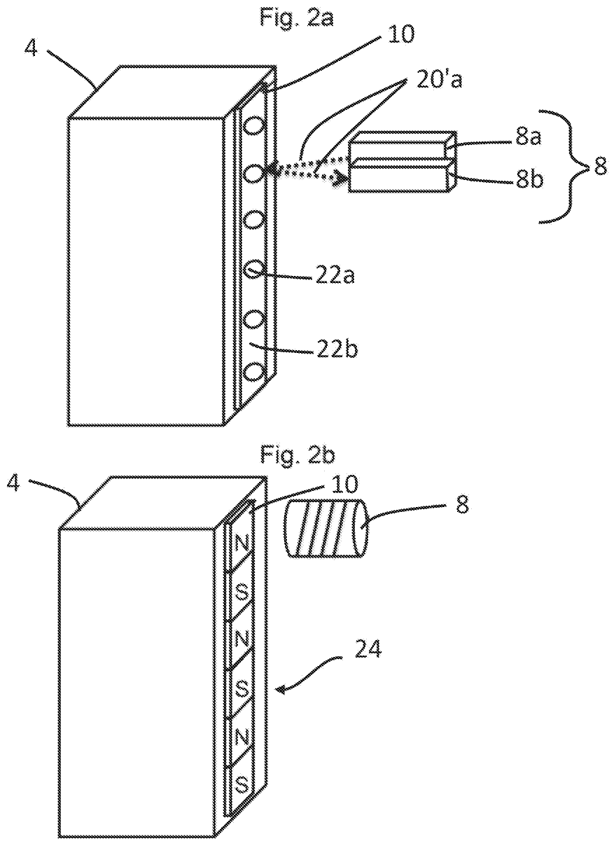

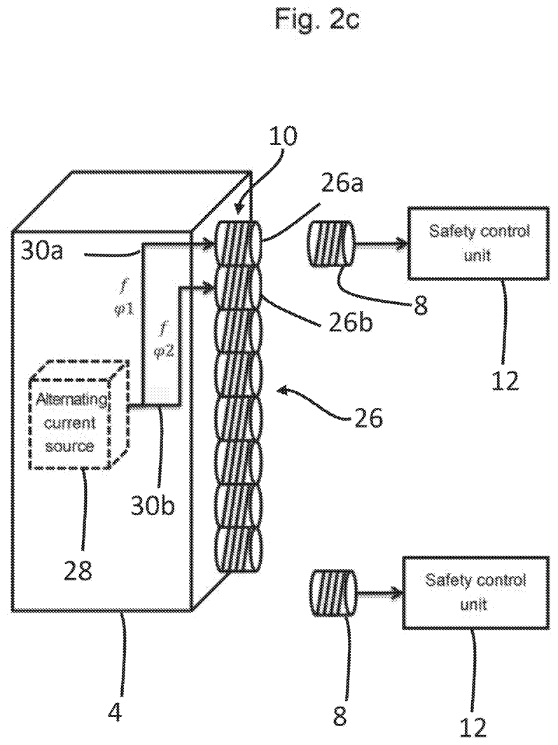

FIG. 2 shows a schematic illustration of an exemplary embodiment of the first aspect of the invention in FIG. 2a, a schematic illustration of an exemplary embodiment of the second aspect of the invention in FIG. 2b and a schematic illustration of an exemplary embodiment of the third aspect of the invention in FIG. 2c;

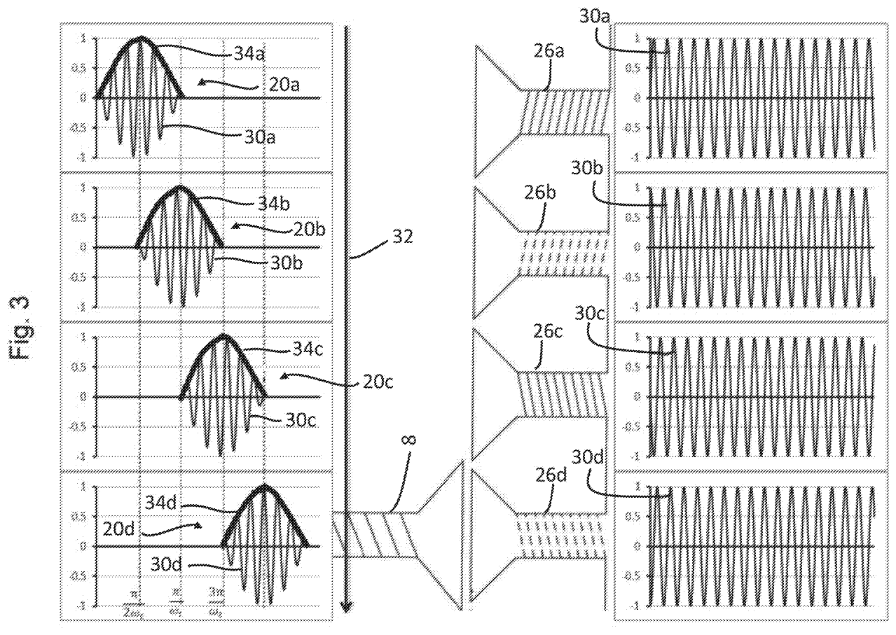

FIG. 3 shows a schematic illustration of an exemplary embodiment of the elevator system, which represents a modification of the previous exemplary embodiment from FIG. 2c;

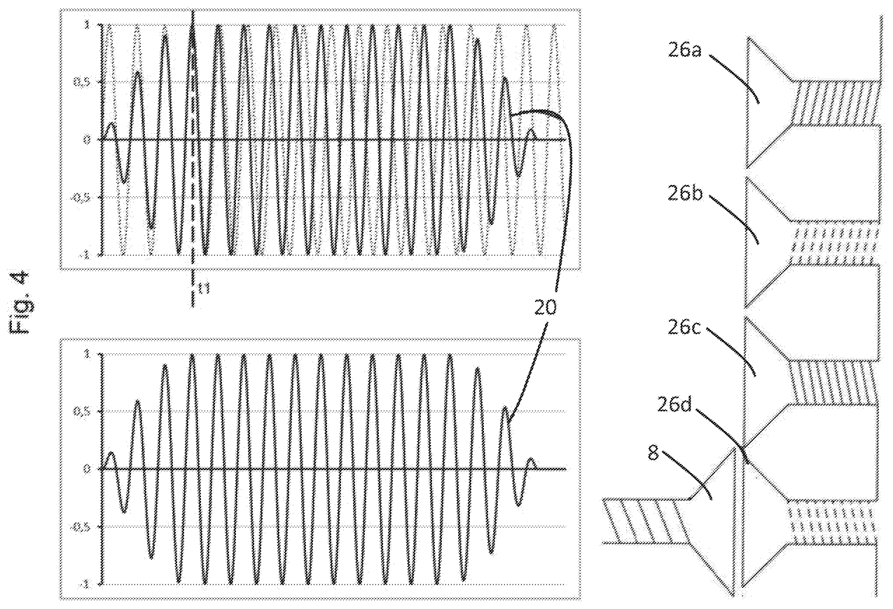

FIG. 4 shows a schematic illustration of a measurement signal, which arises from the exemplary embodiment of FIG. 3;

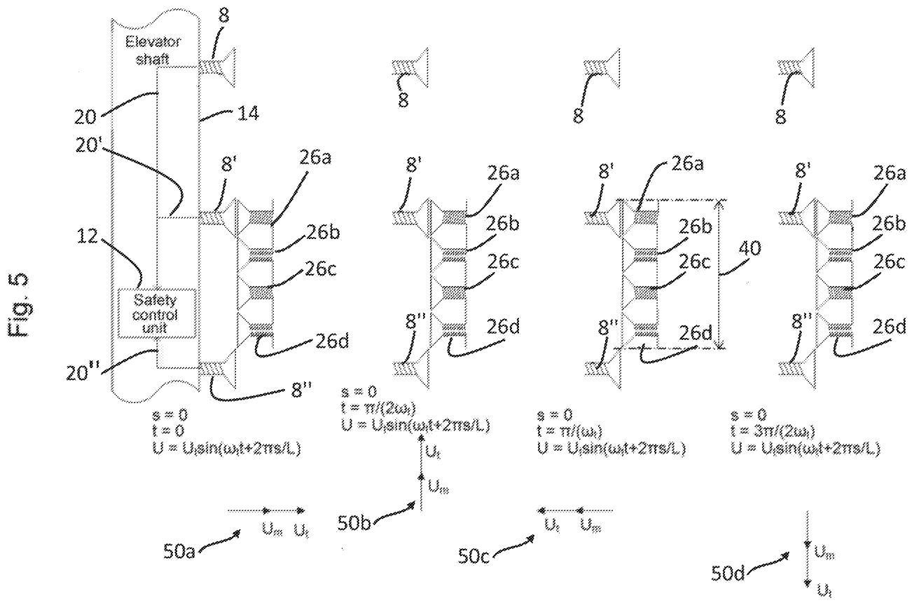

FIG. 5 shows a schematic illustration of the elevator system at four different times when the cab is at a standstill;

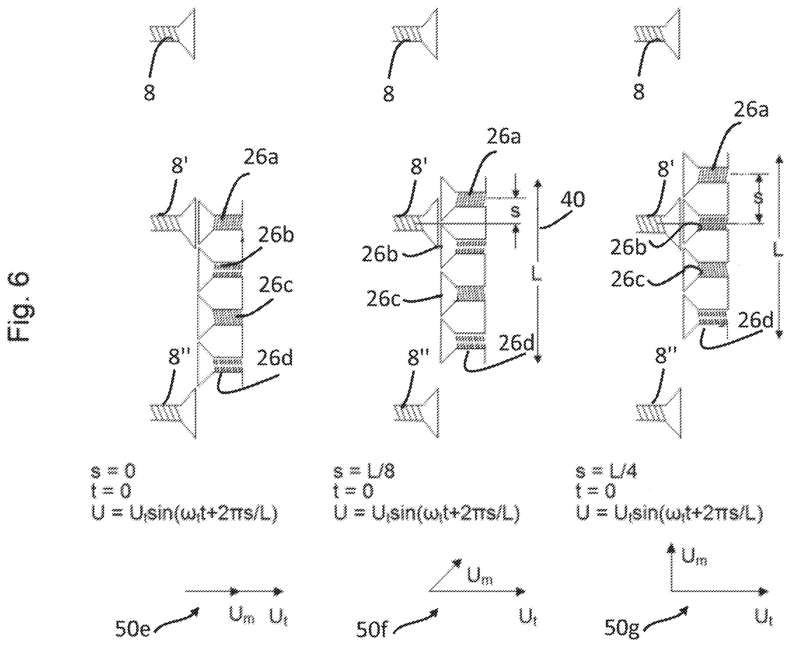

FIG. 6 shows a schematic illustration of the elevator system at three different times when the cab is in motion;

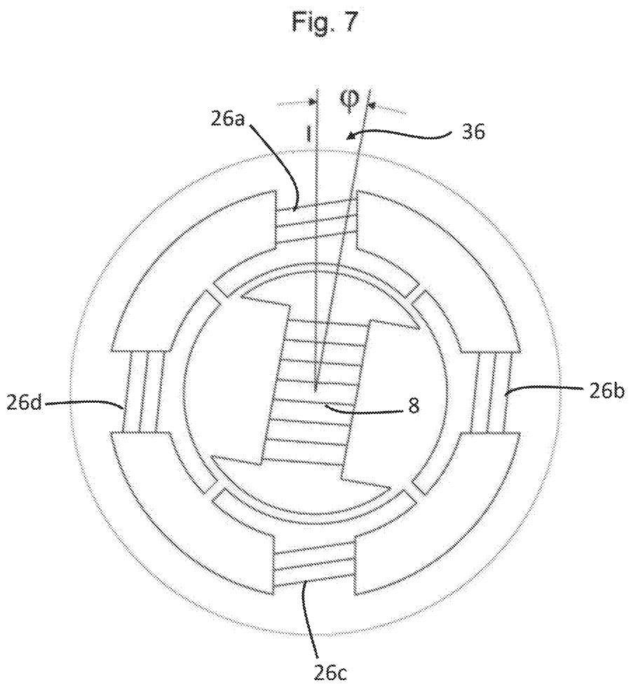

FIG. 7 shows a schematic illustration of a conceptual model for elucidating the phase shift of the measurement signal;

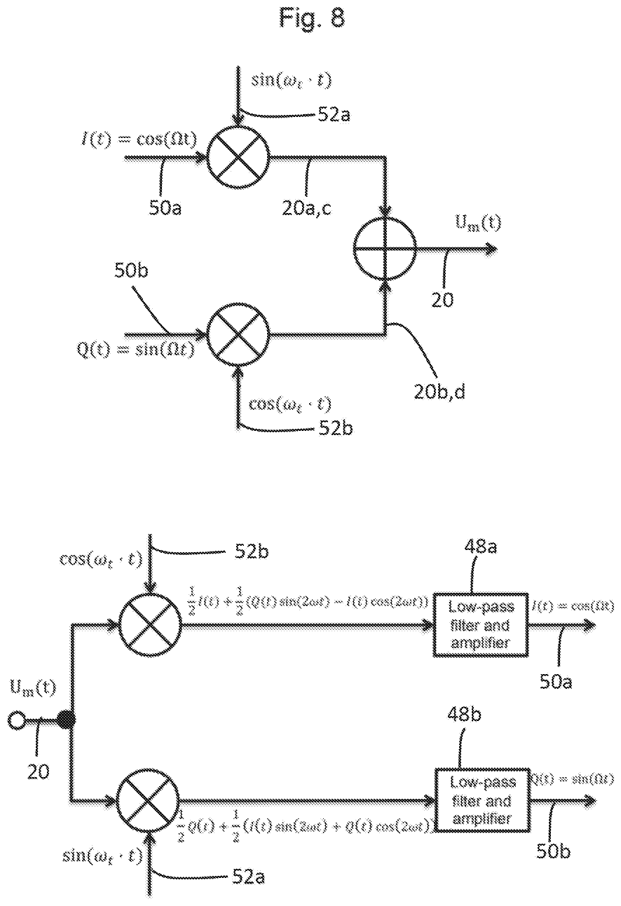

FIG. 8 shows, top, an equivalent circuit diagram depicting the modulation of the measurement signal by means of the moving cab and, bottom, a schematic illustration of an (electrical) demodulator for demodulating the measurement signal; and

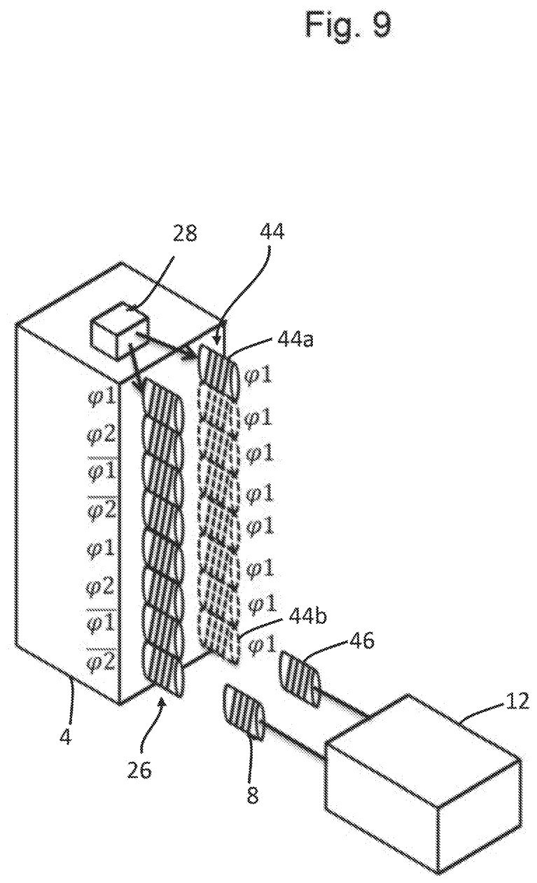

FIG. 9 shows a schematic illustration of a structure of the elevator system according to further exemplary embodiments.

Before exemplary embodiments of the present invention are more closely explained in detail below on the basis of the drawings, attention is drawn to the fact elements, objects and/or structures that are identical, functionally equivalent or have the same effect are provided with the same reference signs in the various figures, and so the description of these elements presented in the different exemplary embodiments is interchangeable or can be applied to one another.

FIG. 1 shows a schematic illustration of an elevator system 2. The elevator system comprises a cab 4, a linear drive 6, a sensor 8, a signal generation unit 10 and a safety control unit 12. The cab 4 is displaceably (or movably) received within an elevator shaft 14 (which is abbreviated to: shaft). The cab 4 is displaceable in, e.g., the vertical direction, as illustrated in FIG. 1. However, the invention is likewise applicable to cabs that are displaceable in other movement directions, for example horizontally or diagonally or obliquely displaceable cabs 4. The signal generation unit 12 should then be disposed on the cab 4 in accordance with the movement direction of the can 4, as will be explained in more detail below in relation to the description of the signal generation unit 12. Should the cabinet be displaceable in a plurality of movements directions, e.g., vertically and horizontally, the signal generation unit can also be disposed on the cab in a plurality of movement directions or in each of the plurality of movement directions. Alternatively, the signal generation unit is disposed on the cab in rotatable fashion.

The linear drive 6 is embodied to drive the cab 4. The linear drive 6 can comprise a stator arrangement 16 fixedly installed in the shaft and a rotor 18 attached to the cab 4. The stator arrangement 16 can comprise a multiplicity of stators successively disposed along the elevator shaft 16 and operated by way of an assigned inverter. The alternator can feed a multi-phase alternating current with at least three phases to each of the assigned stators; individual coils of the stators have respectively one phase current applied thereto in a targeted fashion. Further explanatory descriptions relating to the driving of a cab by means of a linear drive are disclosed in the international patent application WO 2016/102385 A1, for example, there in conjunction with a synchronous motor.

When the cab 4 is moved, the coils situated within the sphere of influence of the rotor each have a phase of the multi-phase alternating current applied thereto in a targeted fashion. The inverters each generate sinusoidal successive phase currents, in each case with a phase offset of 120° in the case of 3-phase stators. The activation of the coils of a second stator of the multiplicity of stators in this case immediately follows the activation of the coils of a first stator of the multiplicity of stators. Consequently, a traveling magnetic field, which drives the rotor 18 ahead of it, is generated by the coils. The structure of the linear drive 6 described herein is only illustrated schematically in FIG. 1 since the invention per se is independent of the linear drive 6 and can also be used in elevator systems with other drives, e.g., a cable drive. However, measuring the acceleration of the cab in elevator systems with a linear drive is significantly more complicated, and so the invention can not only be used be developed as an alternative but also advantageously. This is due, inter alia, to the fact that a plurality of cabs can travel simultaneously and independently of one another in one elevator shaft.

The sensor 8 is disposed in the elevator shaft 14, in particular in fixed fashion. The sensor 8 should be fastened in the elevator shaft 14 in such a way that the sensor 8 has no (mechanical) contact with the cab 4 or the signal generation unit 10. This can minimize wear and losses due to friction. The signal generation unit 10 can be embodied to generate a measurement signal 20 in the sensor 8, which measurement signal depends on a (travel) speed of the cab 4 in the elevator shaft 14. Thus, the signal generation unit can independently (actively) generate an (electromagnetic or magnetic) signal 20′, for example by virtue of the signal generation unit 10 having current flow therethrough or having permanent magnets. Alternatively, the signal generation unit 10 can also passively influence or modulate an external signal and generate a signal that generates the measurement signal 20 in the sensor 8 and that differs from the external signal. Exemplary embodiments for configuring the signal generation unit 10 are described in the following figures.

The safety control unit 12 is embodied to ascertain an acceleration of the cab 4 on the basis of the measurement signal 20. Should the ascertained acceleration exceed a limit value, the safety control unit 12 brings the linear drive 6 into a safety operating state. In order to activate the safety operating state, the safety control unit 12 can transmit corresponding information 21 to the linear drive 6 or to a controller of the linear drive. The measurement signal 20 can be an electrical signal which is generated by the sensor 8 on the basis of the signal 20′ generated by the signal generation unit 10. Expressed differently, the sensor 8 converts the signal 20′ of the signal generation unit 10 into the measurement signal 20. The limit value can be different depending on whether a positive acceleration or a negative acceleration is present. In particular, the limit value for an admissible positive acceleration can be lower than for an admissible negative acceleration. The positive acceleration denotes an acceleration of the cab that results in a force on the passenger acting in the direction of the cab ceiling while a negative acceleration denotes an acceleration of the cab that results in a force on the passenger acting in the direction of the cab floor. Positive acceleration occurs when the cab is traveling upward and brakes or when the cab is traveling downward and accelerates. Negative acceleration occurs when the cab is traveling upward and accelerates or when the cab is traveling downward and brakes. In the entire disclosure, both positive acceleration and negative acceleration are subsumed by the term acceleration, provided no explicit distinction is made.

The invention is applicable to elevator systems (elevator installations) with at least one car (cab), in particular a plurality of cabs, which are displaceable in a shaft via guide rails. At least one fixed first guide rail is fixedly disposed in the shaft and aligned in a first direction, in particular a vertical direction. At least one fixed second guide rail is aligned in a second direction, in particular a horizontal direction, in the shaft. At least one third guide rail, which is rotatable in relation to the shaft, is fastened to a rotary platform and transferable between an alignment in the first direction and an alignment in the second direction. Such systems are basically described in WO 2015/144781 A1 and in the German patent applications 10 2016 211 997.4 and 10 2015 218 025.5.

FIG. 2 shows a schematic illustration of an exemplary embodiment of the first aspect of the invention in FIG. 2a, a schematic illustration of an exemplary embodiment of the second aspect of the invention in FIG. 2b and a schematic illustration of an exemplary embodiment of the third aspect of the invention in FIG. 2c. Further exemplary embodiments of the third aspect are shown from FIG. 3 onward. For an improved overview of the representation, reproducing the elevator shaft 14 and the safety control unit 12 is generally dispensed with such that only the cab 4 and the sensor 8 are illustrated. However, these are disposed in the elevator shaft, as described in FIG. 1.

The sensor 8 in FIG. 2a comprises a transmitter 8a and a receiver 8b. The receiver 8b is embodied to receive a signal 20′a (e.g., an electromagnetic signal) emitted by the transmitter 8a. The signal generation unit 10 in FIG. 2a has an alternate arrangement of a first section 22a and a second section 22b. The first section 22a can guide the electromagnetic signal 20′a to the receiver and the second section 22b can prevent the electromagnetic signal 20′a from being guided to the receiver 8b. The receiver 8b can output the measurement signal 20 (see FIG. 1) on the basis of the received electromagnetic signal 20′a.

Accordingly, the signal generation unit 10 can be a perforated tape, which has a reflecting and absorbing section 22a, 22b. The sensor 8, e.g., a photoelectric barrier, can irradiate the perforated tape, i.e., emit an electromagnetic signal 20′a in the direction of the cab 4 or the signal generation unit 10. The reflecting section (e.g., the first section 22a) casts the electromagnetic signal 20′a back to the receiver 8b. Should the electromagnetic signal 20′a strike the non-reflecting or absorbing section (e.g., the second section 22b) of the signal generation unit, the receiver 8b receives no electromagnetic signal and consequently produces no measurement signal either. In this arrangement, the photoelectric barrier is employed in reflecting fashion. Alternatively, the photoelectric barrier can also be used in transmitting fashion. Then, the first section 22a passes electromagnetic signal of the photoelectric barrier while the second section absorbs the signal or reflects it in the direction of the transmitter. Then, the signal generation unit should be spatially attached between the transmitter and the receiver.

The electromagnetic signal 20′a, and consequently also the measurement signal 20 as an output signal of the receiver 8b, is pulsed by means of the signal generation unit 10 when the cab is in motion. Expressed differently, a binary measurement signal with alternating states is present. A frequency of the pulses or states is proportional to the speed of the cab 4; a change in frequency is proportional to the change in speed and consequently proportional to the acceleration of the cab 4.

The signal generation unit 10 from FIG. 2b comprises a multiplicity of magnets 24 disposed in such a way that they alternately generate a magnetic field in a first direction and in a second direction in the elevator shaft. By way of example, the multiplicity of magnets can be aligned so that their north poles and south poles are alternately directed to the sensor 8. The magnets can be permanent magnets or electromagnets, i.e., for example, a coil through which a direct current flows. The sensor 8 has a magnetic field detector, for example a (receiver) coil 8c. The magnetic field detector 8 can detect the alternating magnetic field and ascertain the acceleration of the cab 4 on the basis of the alternating magnetic field. In the sensor 8, the alternating magnetic field generates (induces) an alternating current as a measurement signal 20 when the cab 4 travels past the sensor 8. The frequency of the alternating current is proportional to the speed of the cab 4. The change in the frequency is proportional to the change in the speed and consequently proportional to the acceleration of the cab 4. In comparison with the embodiment of the first aspect, this embodiment of the second aspect has reduced sensitivity in respect of dirtying of the signal generation unit 10 or of the sensor 8.

The signal generation unit 10 from FIG. 2c comprises a plurality of coils 26 (at least two). A first coil 26a of the plurality of coils is coupled to an alternating current source 28, which is embodied to feed the first coil with an alternating current flow 30a with a first phase displacement (φ1) and a constant frequency (f). A second coil 26b of the plurality of coils is coupled to the alternating current source 28, wherein the second coil 26b can be fed with an alternating current flow 30b with a second phase displacement (φ2) and the constant frequency (f). The alternating current flow can be sinusoidal or cosine-shaped. In the third aspect, the constant frequency (f) is also referred to as carrier frequency.

In one exemplary embodiment, a difference between the first phase displacement (φ1) and the second phase displacement (φ2) (in terms of magnitude) is 180° (or π radians). Further, the frequency (f) should be chosen to be greater than 25 times, 100 times or 1000 times the quotient of a maximum design speed of the cab or the linear drive and a length (L) of the number of coils, which corresponds to the number of different phase displacements or alternating current flows (also referred to as a grid in the disclosure); i.e., from the start of the first coil to the end of the second coil in this case (cf. FIG. 6 for the length L of four coils). Hence, a used signal can be modulated onto the (carrier) frequency (f) by the motion of the cab 4 (cf. also FIG. 3). The used signal forms an envelope for the frequency (f), the frequency of which envelope depends on the speed of the cab. Expressed differently, the frequency (f) is amplitude modulated. The frequency of the envelope is determined from the quotient of the (current) speed of the cab and the sum of the lengths of the two coils, i.e., the length (L). By way of example, the envelope can be extracted by means of a low-pass filter, which filters the carrier frequency from the measurement signal. As a result, the envelope should then be considered in analogous fashion to the exemplary embodiment of the second aspect. A frequency of the envelopes is proportional to the speed of the cab 4; a change in frequency is proportional to the change in speed and consequently proportional to the acceleration of the cab 4. Just like the exemplary embodiment of the second aspect, this exemplary embodiment is insensitive to dirtying. However, the sensor 8 can also receive a measurement signal when the cab is at a standstill in front of the sensor.

FIG. 3 shows a schematic illustration of an exemplary embodiment, which represents a modification of the previous exemplary embodiment. Here, the plurality of coils 26 comprises a third coil 26c and a fourth coil 26d in addition to the first coil 26a and the second coil 26b. The alternating current source (not shown in FIG. 3) can feed a first and a second signal 30a, 30b with a phase shift of 90°, e.g., a sine and cosine, to the first and the second coil. The alternating current source can feed a third signal 30c to the third coil 26c, which third signal has a 180° phase shift in relation to the first signal 30a. The alternating current source can feed a fourth signal 30d to the fourth coil 26d, which fourth signal has a 180° phase shift in relation to the second signal 30b. In FIG. 3, the signals 30a-30d are selected in ascending order as follows: sine, cosine, negative sine (−sin), negative cosine (−cos). These signals serve as a carrier signal. The frequency of the signals 30a-30d is advantageously identical and, for example, lies between 1 kHz and 10 MHz. A typical frequency is more than 5 kHz, more than 50 kHz or more than 200 kHz. Consequently, the coils 26a-26d each generate an alternating magnetic field, which can be detected by the sensor 8. Detection is implemented by inducing an alternating current in the sensor 8, which has a coil or conductor loop, for example. Furthermore, the sensor in the coil can have an (iron) core, which is closed with a pole piece. The transmitter coils 26 can also have the same structure.

Should, purely for illustration, the sensor 8 not superimpose the measurement signals but detect these individually, the sensor 8 would receive the individual measurement signals 208-20d, illustrated schematically in FIG. 3, when the cab moves in the movement direction 32. The individual measurement signals 20a-20d each have the carrier signal 30a-30d, which is amplitude-modulated by the movement of the cab, as a result of which the individual measurement signals 20a-20d are each limited by the envelope 34a-d. The envelope is also referred to as used signal or modulation signal.

The resultant measurement signal 20 arises from the superposition of the individual measurement signals 20a-20d. FIG. 4 shows two schematic illustrations of this signal. The measurement signal 20 is shown individually at the bottom whereas the top illustrates the measurement signal 20 (full line) in comparison with a pure sinusoidal signal (dashed line). From the comparison of the measurement signal 20 with the sinusoidal signal, it is clear that these are congruent at first. This is the case until the coil 26a and the sensor 8 are opposite one another (in congruent fashion) or until the magnetic field generated by the coil 26b is superposed by the magnetic field generated by the coil 26a in the detection region of the sensor 8. After this time t1, the frequency of the measurement signal increases by the superposition of adjacent magnetic fields, which induce a (90°) phase-shifted current in the sensor 8. A phase angular speed of the measurement signal also increases with the frequency. Expressed differently, a phase difference arises between the measurement signal 20 and the sinusoidal signal.

In FIG. 5 and FIG. 6, the phase angles are shown again on the basis of phasor diagrams 50a-g in a total of 7 states. In the four illustrations of FIG. 5, the coils 26a-d on the cab are at a standstill, i.e., at the same position relative to the sensors 8, 8′ and 8″. However, between the four illustrations is the time difference of π/2ωₜ where ωₜ is the angular frequency of the carrier signal. It is clear from the phasor diagrams that both the voltage Uₜ with which the coils 26a-d are fed by the alternating current source and the measurement voltage Uₘ 20 rotate through 90° with each time step. Both voltages run synchronously at the same phase angular velocity.

FIG. 6 illustrates the elevator system with a traveling cab. The three shown states each image the state at the same time (or a time difference of multiples of 2π/ωₜ). While the voltage of the measurement signal Uₘ and the voltage of the carrier signal Uₜ still have the same phase angle in the first illustration, the phase angle has shifted by 45° in the second illustration. This phase angle shift arises from the superposition of the carrier signals of the two coils 26a, 26b, which each overlap with the sensor 8′ in equal parts, i.e., by approximately 50%. The third image shows a further offset of the coils 26a-d in relation to the sensor 8′ by half the length of the coil 26′. The second coil 26b and the sensor 8′ overlap completely. The sensor 8′ only receives the carrier signal of the second coil 26b, which is phase-shifted by 90° with respect to the carrier signal of the first coil 26a. Accordingly, the phase of the measurement signal Uₘ also has an angle of 90° with respect to the phase of the carrier signal of the first coil. The following facts result mathematically: Uₘ=Uₜ sin (ωₜt+2π·s/L), where, in addition to the variables already specified, t denotes time, s denotes the offset of the center of the first coil with respect to the center of the sensor and L denotes the overall length of the four measurement coils.

In FIG. 7, this phase difference 36 is elucidated again on the basis of a conceptual model by virtue of the coils 26a-26d being disposed not in linear fashion but, in a manner similar to the stator of an electric motor, in a circle around the sensor 8, which takes the place of the rotor in this case. If the carrier signals 30a-30d are fed to the coils 26a-26d, it is obvious that the resulting measurement signal of the sensor 8 in every possible position, i.e., in every rotational angle of the sensor 8, has a phase angle, corresponding to the rotational angle, with respect to the sinusoidal signal feeding the coil 26a.

FIG. 8, top, shows a schematic illustration of an electrical equivalent circuit diagram for generating the measurement signal Uₘ(t). With respect to FIG. 3, the signal l(t) represents the envelopes 34a,c of the individual measurement signals 20a,c and the signal Q(t) represents the envelopes 34b,d of individual measurement signals 20b,d. From a mathematical point of view, the individual measurement signals 20a-d from FIG. 3 with the angular frequency Ω of the used signal or the envelopes and with the angular frequency ωₜ of the carrier signal can be defined section-by-section as follows:

$$For \frac{π}{2 {ω}_{t}} \leq Ω < \frac{π}{{ω}_{t}} \text{:} sin ( {ω}_{t} t ) \cdot cos ( Ω t ) + cos ( {ω}_{t} t ) \cdot sin ( Ω t )$$

$$For \frac{π}{{ω}_{t}} \leq Ω < \frac{3 π}{2 {ω}_{t}} \text{:} cos ( {ω}_{t} t ) \cdot cos ( Ω t ) + - sin ( {ω}_{t} t ) \cdot sin ( Ω t ) = sin ( {ω}_{t} t ) \cdot - sin ( Ω t ) + cos ( {ω}_{t} t ) \cdot cos ( Ω t )$$

$$For \frac{3 π}{{ω}_{t}} \leq Ω < \frac{2 π}{{ω}_{t}} \text{:} - sin ( {ω}_{t} t ) \cdot cos ( Ω t ) + - cos ( {ω}_{t} t ) \cdot sin ( Ω t ) = sin ( {ω}_{t} t ) \cdot - cos ( Ω t ) + cos ( {ω}_{t} t ) \cdot - sin ( Ω t )$$

$$For \frac{2 π}{{ω}_{t}} \leq Ω < \frac{5 π}{2 {ω}_{t}} \text{:} - cos ( {ω}_{t} t ) \cdot cos ( Ω t ) + sin ( {ω}_{t} t ) \cdot sin ( Ω t ) = sin ( {ω}_{t} t ) \cdot sin ( Ω t ) + cos ( {ω}_{t} t ) \cdot - cos ( Ω t )$$

By inserting the sections, the following overall function arises for the measurement signal: Uₘ(t)=sin(ωₜt)·cos(Ωt)+cos(ωₜt)·sin(Ωt)=l(t)·sin(ωₜt)+Q(t)·cos(ωₜt).

This function and the upper illustration in FIG. 8 describe the modulation. The first term l(t)·sin(ωₜt) comprises the individual measurement signals 20a and 20c while the second term Q(t)·cos (ωₜt) comprises the individual measurement signals 20b and 20d from FIG. 3. l(t) 50a is also referred to as in-phase component and Q(t) 50b is also referred to as quadrature component. The combined carrier signal becomes sin(ωₜt) 52a, the Hilbert-transformed carrier signal of which or the 90° phase-shifted carrier signal becomes cos(ωₜt) 52b.

The used signals can be recovered from the measurement signal by means of (electronic) coherent demodulation provided the frequency and the phase displacement of the carrier signal are known on the receiver side, i.e., in the safety control unit, for example. Coherent demodulation is described in FIG. 8 below. Transmitting the frequency and the phase displacement of the carrier signal can be implemented, for example, by a second track located parallel to the coils of the signal generation unit and having transmission coils of one of the two carrier signals and a second sensor with receiver coils, which is disposed parallel to the sensor 8 (cf. FIG. 9). It is possible to deduce the spatial displacement of the car with respect to the sensor 8 on the basis of the phase displacement of the carrier signal (reconstructed on the receiver side) relative to the measurement signal. The phase displacement of the measurement signals with respect to the carrier signal can be ascertained from the reconstructed used signals. In the case of coherent demodulation, the first used signal is reconstructed by multiplying the measurement signal by the carrier signal and the second used signal is reconstructed by multiplying the measurement signal by the Hilbert-transformed or 90° phase-shifted carrier signal, each used signal being reconstructed from the measurement signal and the used signals being obtained following the multiplication by the gain (by the factor 2) and local pass filtering 48a, 48b. If the first used signal l(t) plotted along the x-direction is subject to vector addition on the unit circle with the second used signal Q(t) plotted along the y-direction, then the phase shift of the measurement signal with respect to the carrier signal emerges from the position of the resulting vector. Expressed differently, the phase shift α is determinable from

$$α = 2 π \frac{s}{L} = {tan}^{- 1} ( \frac{Q ( t )}{I ( t )} ) ,$$

where tan⁻¹=arctan denotes the arctangent. In the case of a fault, the phase shift may change not continuously but, for example, discontinuously or suddenly and, for example, also run against the normal running direction. Such a discontinuous profile results from a greater acceleration of the cab. In telecommunications engineering, this modulation method is used in quadrature amplitude modulation, for example.

If a plurality of sets of coils of four coils each are disposed on the cab, it is initially possible to ascertain only a point in a coil set but not the relevant coil set itself (result modulo L). However, the number of the current coil set can be ascertained by counting the complete (360°) revolutions of the phase displacement α. As an alternative to counting the revolutions the phase shift, it is also possible to carry out a frequency difference measurement between the measurement signals of the sensor 8 and of the further sensor 46 (cf. FIG. 9). By way of example, the number of the current coil set can be ascertained by counting the number of times where the two signals are in phase, i.e., no phase difference is present.

FIG. 9 shows a schematic structure of the elevator system according to an exemplary embodiment, in which the measurement signal is demodulated by means of coherent demodulation. The signal generation unit disposed on the cab 4 comprises the plurality of coils 26, which are strung linearly, vertically in this case, along a movement direction of the cab 4. Additionally, a further coil 44a is disposed on the cab 4, at a horizontal distance from the plurality of coils 26, said further coil being coupled to the alternating current source 28 and the alternating current source 28 being embodied to feed the alternating current with the constant frequency (f) and the first phase displacement (φ1) to the further coil 44a. Alternatively, the alternating current can also have the second phase displacement (φ2). Additionally, a further sensor 46 is disposed on the elevator shaft, said further sensor being embodied to detect a magnetic field generated by the further coil 44a. The magnetic field generates a reference alternating current in the further sensor 46, from which it is possible to ascertain the frequency (f) and the set phase displacement φ1 or φ2. Using these parameters, it is possible to reconstruct (i.e., generate by means of a signal generator or an alternating current source, for example) the carrier signal, for example in the safety control unit 12, and said carrier signal can be used to demodulate the measurement signal by means of coherent demodulation, as described above.

Optionally, the cab has a second further coil 44b in addition to the further coil 44a, the alternating current with the constant frequency f and the first phase displacement φ1 or optionally the second phase displacement φ2 likewise being fed to said second further coil. Consequently, the further sensor 46 can ascertain the carrier signal by way of the coils 44a, 44b attached to the two ends of the cab directly upon entry of the first coil of the plurality of coils 26 into the detection range of the sensor 8, during both upward and downward travel of the cab 4.

In exemplary embodiments, the cab has a plurality of further coils 44 parallel to the plurality of coils 26, each comprising the same number of coils. Accordingly, both the plurality of coils 26 and the further plurality of coils 44 can be disposed linearly along the direction of travel of the cab. Consequently, the further sensor 46 directly receives the carrier signal in parallel with the measurement signal, and so the coherent demodulation can be applied to the measurement signal for the purposes of reconstructing the carrier signal without further signal processing steps (with the exception of the Hilbert transform).

As already illustrated in FIG. 1, equipping the signal generation unit with separate coils and not resorting to the coils of the linear drive is advantageous. Consequently, the resolution of the position measurement can be increased by virtue of the coils of the signal generation unit and of the sensor being made as small as possible. The stator and rotor coils of the linear drive are not designed to measure signals, but only to drive or move the cab. Therefore, the coils are relatively large. They can have a length, i.e., a (vertical) extend parallel to the traveled path of the cab, of at least 25 cm. A certain robustness of the coils for driving the cab is also required on account of the power to be transmitted. If these coils were used to measure speeds, they would have a comparatively poor resolution account of the relatively large extent, and so accelerations of the cab could only be ascertained with comparatively low precision. It is therefore advantageous to use separate coils to measure the speed or acceleration of the cab. These can have a shorter length (or diameter in the case of round coils) than the coils of the linear drive. The length of the coil denotes an extent in the direction of travel of the cab. Thus, the coil(s) of the sensor and the coils of the signal generation unit can have a length or a diameter of between 0.1 cm and 20 cm. In exemplary embodiments, the length of the coils is less than 10 cm, less than 5 cm or less than 1 cm.

FIG. 5 additionally shows a further exemplary embodiment of the elevator system 2 using the example of the third aspect, although this can also be applied to the first and second aspect. Thus, one or more safety control units 12 can be dispensed with in the case of an appropriate arrangement of the sensors 8 along the elevator shaft 14, by virtue of one safety control unit 12 being (electrically) connected to a plurality of sensors 8 and evaluating the measurement signals 20 of the connected sensors 8. In FIG. 5, three sensors 8, 8′, 8″ are connected to the safety control unit 12 in exemplary fashion, the safety control unit 12 receiving and evaluating the measurement signals 20, 20′, 20″ of said sensors. For the evaluation of a plurality of measurement signals by a single safety control unit 12, it is advantageous for the sensors 8 to have a spacing that corresponds to an integer multiple of a grid 40 of the signal generation unit. In the case of the first aspect, the grid 40 corresponds to the length between two adjacent centers of the first section, for example the length between two adjacent hole centers of the perforated tape. In the case of the second aspect, the grid corresponds to the length of two magnets. In the case of the third aspect, the grid 40 corresponds to a length of the number of coils over which the carrier signal repeats. These are two coils in the case of 180° shifted carrier signals and four coils in the case of 90° shifted carrier signals between two adjacent coils. Consequently, the grid 40 in FIG. 5 corresponds to the length L (cf. also FIG. 6, e.g., the sum of the diameters) of four coils. The number of coils in a grid is also referred to as a coil set. Accordingly, FIG. 4 to FIG. 6 each show a coil set on the cab 4. FIG. 9 shows an exemplary embodiment in which the signal generation unit has 8 coils and consequently two coil sets.

In general, a plurality of coil sets can be disposed on the cab 4. These can cover the entire height of the cab. In the case of a cab height of 2.50 m and a coil length of 5 cm, this would allow 12 coil sets to be attached to the cab if a coil set comprises four coils. Consequently, one sensor 8 can continuously monitor the speed of the cab 4 over the entire height of the cab. Accordingly, the distance 42 between two sensors 8 in the elevator shaft can be 2.40 m, i.e., the number of coil sets multiplied by the grid, i.e., the length of the coil set. The distance between the centers of two sensors can be viewed as the distance between the two sensors.

If the sensors have an integer multiple of the grid of the signal generation unit and if this multiple is less than the number of grids of the signal generation unit, the signal generation unit generates a measurement signal in the two of the sensors at certain times. These two measurement signals superpose and thus generate a resultant measurement signal with twice the amplitude of the measurement signals of the two sensors. By counting these double amplitudes, it is possible to determine the sensor that receives the measurement signal with the normal amplitude (not twice the amplitude). In other words, the distance between the sensors is less than the length of the signal generation unit. However, the distance between the sensors is chosen in such a way that it corresponds to a multiple of the distance between two coils that carry the alternating current signal with the same phase displacement.

Even though some aspects were described in conjunction with an apparatus, it is understood that these aspects also represent a description of the corresponding method, and so a block or component of an apparatus should also be understood to be a corresponding method step or a feature of a method step. In a manner analogous thereto, aspects that were described in conjunction with, or as, a method step also represent a description of a corresponding block or detail or feature of a corresponding apparatus.

Depending on the specific implementation requirements, it is possible for exemplary embodiments of the invention to be implemented in hardware or in software. The implementation can be performed using a digital storage medium, for example a floppy disk, a DVD, a Blu-Ray disk, a CD, a ROM, a PROM, an EPROM, an EEPROM or a FLASH memory, a hard disk or another magnetic or optical storage means which stores electronically readable control signals which can interact, or do interact, with a programmable computer system in such a way that the respective method is carried out. The digital storage medium can therefore be computer-readable. Some exemplary embodiments according to the invention therefore comprise a data storage medium which has electronically readable control signals which are able to interact with a programmable computer system in such a way that one of the methods described herein is carried out.

In general, exemplary embodiments of the present invention can be implemented as a computer program product with a program code, wherein the program code is effective for performing one of the methods when the computer program product is executed on a computer. The program code can also be stored, for example, on a machine-readable medium. Other exemplary embodiments comprise the computer program for performing one of the methods described herein, wherein the computer program is stored on a machine readable medium.

Expressed differently, one exemplary embodiment of the method according to the invention is consequently a computer program having program code for performing one of the methods described herein when the computer program is executed on a computer. A further exemplary embodiment of the methods according to the invention is consequently a data medium (or digital storage medium or a computer-readable medium), on which the computer program for performing one of the methods described herein is stored.

A further exemplary embodiment of the method according to the invention is consequently a data stream or sequence of signals, which represents or represent the computer program for performing one of the methods described herein. By way of example, the data stream or the sequence of signals can be configured to the effect of being transferred via a data communication link, for example via the Internet.

A further exemplary embodiment comprises a processing device, for example a computer or programmable logic element, which is configured or adapted to the effect of performing one of the methods described herein.

A further exemplary embodiment comprises a computer, on which the computer program for performing one of the methods described herein is installed.

In some exemplary embodiments, a programmable logic element (for example, field-programmable gate array, FPGA) can be used to perform some or all of the functionalities of the methods described herein. In some exemplary embodiments, a field-programmable gate array can interact with a microprocessor so as to perform one of the methods described herein. In general, the methods are performed by any hardware apparatus in some embodiments. This can be universally employable hardware such as a computer processor (CPU) or hardware specific to the method, such as an ASIC, for example.

The above-described exemplary embodiments only represent an elucidation of the principles of the present invention. It is understood that modifications and variations of the arrangements and details described herein will be evident to other persons skilled in the art. Therefore, the intention is that the invention is only restricted by the scope of protection provided by the patent claims below and not by specific details that were presented herein on the basis of the description and the explanations of the exemplary embodiments.

### LIST OF REFERENCE SIGNS

Elevator system 2
Cab 4
Linear drive 6
Sensor 8, 8′, 8″
Transmitter 8a
Receiver 8b
Receiver coil 8c
Signal generation unit 10
Safety control unit 12
Elevator shaft 14
Stator arrangement 16
Rotor 18
Measurement signal 20, 20a, 20b, 20c, 20d, 20′, 20″
Signal of the signal generation unit 20′
Electromagnetic signal 20′a
First and second section of the signal generation unit 22a, 22b
Magnets 24
Plurality of coils 26, 26a, 26b, 26c, 26d
Alternating current source 28
(Carrier) signal 30a, 30b, 30c, 30d
Movement direction 32
Envelope 34a, 34b, 34c, 34d
Phase difference 36
Distance 38
Grid 40
Further coil 44
Further sensor 46
Gain and low-pass filtering 48
In-phase component l(t) 50a
Quadrature component Q(t) 50b
Combined carrier signal 52a, 52b

1.-15. (canceled)

16. An elevator system comprising:
a cab displaceably received within an elevator shaft;
a linear drive configured to drive the cab;
a sensor disposed in the elevator shaft;
a signal generation unit disposed on the cab and embodied to generate a measurement signal in the sensor, wherein the measurement signal depends on a speed of the cab in the elevator shaft; and
a safety control unit embodied to ascertain an acceleration of the cab on the basis of the measurement signal and to bring the linear drive into a safety operating state when the ascertained acceleration exceeds a limit value.

17. The elevator system of claim 16 wherein the signal generation unit has a plurality of coils, wherein a first coil of the plurality of coils is coupled to an alternating current source, which is configured to feed the first coil with an alternating current with a first phase displacement and a constant frequency, and wherein a second coil of the plurality of coils is coupled to the alternating current source, which is configured to feed the second coil with an alternating current with a second phase displacement and the constant frequency.

18. The elevator system of claim 17 wherein the plurality of coils includes a third coil and a fourth coil, wherein a difference between the first phase displacement and the second phase displacement is 90° and wherein the alternating current source is embodied to feed the third coil with the alternating current of the first coil phase-shifted by 180° and feed the fourth coil with the alternating current of the second coil phase-shifted by 180°.

19. The elevator system of claim 17 wherein the alternating current source is configured to feed one coil of the plurality of coils with a Hilbert-transformed signal of the respective neighboring coil.

20. The elevator system of claim 17 wherein the safety control unit for ascertaining the acceleration of the cab comprises a demodulator configured to demodulate the measurement signal by means of coherent demodulation.

21. The elevator system of claim 18 wherein the plurality of coils of the signal generation unit are linearly strung in succession along a movement direction of the cab;
wherein a further coil is disposed on the cab with a horizontal distance from the signal generation unit, said further coil being coupled to the alternating current source, wherein the alternating current source is configured to feed the further coil with the alternating current with the constant frequency and the first phase displacement (φ1) or the second phase displacement (φ2); and
wherein a further sensor is disposed on the elevator shaft, said further sensor being embodied to detect a magnetic field generated by the further coil.

22. The elevator system of claim 16 wherein, for the purposes of ascertaining the acceleration of the cab, the safety control unit determines a phase angle of the measurement signal in order to obtain a position of the cab and differentiates the phase angle twice with respect to time in order to ascertain the acceleration of the cab.

23. The elevator system of claim 16 wherein the signal generation unit has an alternating arrangement of a first section and a second section;
wherein the sensor comprises a transmitter and a receiver, wherein the receiver is configured to receive an electromagnetic signal (20′a) emitted by the transmitter; wherein the first section is configured to guide the electromagnetic signal to the receiver and
wherein the second section is configured to prevent the electromagnetic signal from being guided to the receiver, wherein the receiver outputs the measurement signal on the basis of the received electromagnetic signal.

24. The elevator system of claim 16 wherein the signal generation unit comprises a multiplicity of magnets disposed such that they alternately generate a magnetic field in a first direction and in a second direction in the elevator shaft; and
wherein the sensor has a magnetic field detector configured to detect the alternating magnetic field and ascertain the acceleration of the cab on the basis of the alternating magnetic field.

25. The elevator system of claim 16 comprising at least one cab which is displaceable in a shaft by way of guide rails,
at least one fixed first guide rail, which is fixedly aligned in a first direction;
at least one fixed second guide rail, which is fixedly aligned in a second direction;
at least one rotatable third guide rail, which is fastened to a rotary platform and which is transferable between an alignment in the first direction and an alignment in the second direction.

26. A method for operating an elevator system, comprising:
displacing a cab movably disposed within an elevator shaft;
driving the cab using a linear drive;
disposing a sensor in the elevator shaft;
disposing a signal generation unit on the cab;
generating a measurement signal in the sensor, wherein the measurement signal depends on the speed of the cab in the elevator shaft;
ascertaining an acceleration of the cab on the basis of the measurement signal; and
bringing the linear drive into a safety operating state should the ascertained acceleration exceed a limit value.

27. A method for measuring an acceleration of a cab of an elevator system, comprising:
generating a succession of at least four alternating magnetic fields on the cab that differ from one another, wherein adjacent alternating magnetic fields are perpendicular to one another, wherein the succession of the at least four alternating magnetic fields is strung along a direction of travel of the cab, and wherein the succession of at least four alternating magnetic fields generates a resultant magnetic field;
displacing the cab movably disposed within an elevator shaft of the elevator system;
measuring a measurement signal at a measurement position in the elevator shaft, the measurement signal being generated by the resultant magnetic field when the cab passes the measurement position; and
decoding the measurement signal to obtain information relating to an acceleration of the cab at the measurement position in the elevator shaft.

28. The method of claim 27 wherein the decoding the measurement signal, comprises:
determining a sequence of positions of the cab relative to the measurement position in the elevator shaft from a phase angle of the measurement signal; and
differentiating a position of the cab twice in order to obtain the acceleration of the cab at the measurement position of the cab.

29. The method of claim 28 wherein the phase angle of the measurement signal is determined from a first and a second modulation signal, wherein the first modulation signal modulates a first alternating magnetic field of the at least four alternating magnetic fields, and
wherein the second modulation signal modulates a second alternating magnetic field of the at least four alternating magnetic fields, wherein the first and the second modulation signal emerge from the displacement of the cab relative to the measurement position.

30. A computer program having program code for performing the method of claim 26 when the computer program is executed on a computer.

31. A computer program having program code for performing the method of claim 27 when the computer program is executed on a computer.
